(19) United States
(12) Patent Application Publication
(10) Pub. No.: US 2015/0091529 A1
(43) Pub. Date: Apr. 2, 2015

(54) PRE-CHARGING AND PRE-DISCHARGING DEVICE FOR ENERGY STORAGE SYSTEM

(71) Applicant: NingDe Contemporary Amperex Technology Limited, Ningde City (CN)

(72) Inventors: Shengguo HUANG, Ningde City (CN); Shilin HUANG, Ningde City (CN)

(73) Assignee: NingDe Contemporary Amperex Technology Limited, Ningde City (CN)

(21) Appl. No.: 14/219,961

(22) Filed: Mar. 19, 2014

(30) Foreign Application Priority Data
Sep. 30, 2013 (CN) 201320612352.3

(51) Int. Cl. H02J 7/00

(52) U.S. Cl. CPC H02J 7/0029; H02J 7/007; H02J 7/0068; H02J 2007/0037; H02J 2007/004; H02J 2007/0098
USPC 320/128

(57) ABSTRACT

A pre-charging and pre-discharging device includes: a charging-discharging device, a master control cabinet, a master switch device, a terminal box device and a test component, wherein the master control cabinet is connected with the energy storage system, the master switch device is connected with the charging-discharging device through a cable and the master switch device is further connected with the master control cabinet, the terminal box device is connected with the master control cabinet, the test component is connected with the energy storage system and the test component is further connected with the terminal box device through a cable.

### FIELD OF THE INVENTION

The disclosure belongs to the technical field of energy storage test equipment, and in particular to a pre-charging and pre-discharging device for an energy storage system.

### BACKGROUND OF THE INVENTION

Energy storage technology is widely applied to information technology industry, energy efficiency and environmental protection industry, biology industry and other fields in the 12th Five-Year Plan of New Industries Development. Energy storage technology mainly includes physical energy storage, chemical energy storage and electromagnetic energy storage.

In conventional art, during the use of energy storage system, all energy storage systems are connected through a cable only, without protection measures; during the charging and discharging process, it is required to conduct manual monitoring and observe over-discharge and over-charge by naked eyes; if over-discharge or over-charge occurs, power supply is interrupted manually. Therefore, intelligent monitoring can not be realized for the charging and discharging process; moreover, the charging and discharging site is messy, the wiring of high-voltage lines is dangerous, and safety hazard can not be eliminated; further, the workload of wiring is heavy, the wire is complex and the requirement of quick production can not be met.

Besides the above, conventional art can not ensure that each battery is reasonably managed after reaching a threshold during the online charging and discharging process.

### SUMMARY OF THE INVENTION

In view of the defect existing in conventional art, the disclosure aims at providing a pre-charging and pre-discharging device for an energy storage system, which can charge and monitor on line a plurality of loads simultaneously, and can improve the safety performance of online charging, reduce the workload of wiring and improve the efficiency of wiring due to reasonable site planning.

In order to achieve the above aim, the disclosure adopts a technical scheme as follows.

The disclosure provides a pre-charging and pre-discharging device for an energy storage system, including:

a charging-discharging device;

a master control cabinet used for monitoring a power supply and charging-discharging signals of the charging-discharging device, wherein the master control cabinet is connected with the energy storage system;

a master switch device, wherein the master switch device is connected with the charging-discharging device through a cable and the master switch device is further connected with the master control cabinet;

a terminal box device used for shunting the input current from the master control cabinet, wherein the terminal box device is connected with the master control cabinet; and

a test component used for charging a load, wherein the test component is connected with the energy storage system and the test component is further connected with the terminal box device through a cable.

As an improvement of the pre-charging and pre-discharging device for the energy storage system of the disclosure, the energy storage system is provided with a Slave Battery Management System (SBMS) and the master control cabinet is provided with a Master Battery Management System (MBMS).

As an improvement of the pre-charging and pre-discharging device for the energy storage system of the disclosure, the master switch device includes a Power Conversion System (PCS) high-voltage output unit, a high-voltage output control and protection unit and a three-phase power input unit, wherein the PCS high-voltage output unit plays the role of high voltage output, the high-voltage output control and protection unit plays the role of high voltage output protection and short-circuit protection, the three-phase power input unit plays the role of connecting PCS three-phase power input.

As an improvement of the pre-charging and pre-discharging device for the energy storage system of the disclosure, the master control cabinet includes:

a load control switch used for connecting the energy storage system and the master control cabinet;

an Uninterruptable Power Supply (UPS) unit;

a computer monitoring unit used for connecting with the communication and transceiving instruction of the energy storage system to control the SBMS of the energy storage system;

a UPS output conversion unit;

a three-phase power input conversion unit used for converting three-phase power into mains supply input;

a current busbar used for converging the current sent from the master switch device, wherein the current busbar mainly is used when large current is input and output.

The three-phase power supplies power to the computer monitoring unit after passing through the three-phase power input conversion unit, the UPS output conversion unit and the UPS power supply unit in turn; and the mains power supplies power to the computer monitoring unit after passing through the UPS output conversion unit and the UPS power supply unit in turn.

As an improvement of the pre-charging and pre-discharging device for the energy storage system of the disclosure, the terminal box device includes: a first high-voltage input unit used for inputting the high voltage supplied by the master control cabinet to the test component, a first mains power input unit used for inputting the mains power to the energy storage system, and a first communication unit used for connecting the energy storage system and the master control cabinet by way of signal.

As an improvement of the pre-charging and pre-discharging device for the energy storage system of the disclosure, the test component includes a plurality of test stub groups.

As an improvement of the pre-charging and pre-discharging device for the energy storage system of the disclosure, each test stub group includes 2 to 20 test stubs.

As an improvement of the pre-charging and pre-discharging device for the energy storage system of the disclosure, the test stub includes: a second high-voltage input unit used for inputting the high voltage output by the terminal box device to the energy storage system, a second mains power input unit used for inputting the mains power to the energy storage system, and a second communication unit used for connecting the energy storage system and the master control cabinet by way of signal.

Generally, the pre-charging and pre-discharging device performs high-voltage energy storage at low loading time, or performs active energy storage of high voltage grid in emergency.

Compared with conventional art, the disclosure can charge and monitor on line a plurality of loads simultaneously; due to reasonable site planning, the disclosure greatly improves the safety performance of online charging, reduces the workload of wiring and improves the efficiency of wiring. In addition, the disclosure also can reasonably simulate the operation of energy storage and predicts in advance problems that probably would occur during operation.

In addition, the connection of each unit in the pre-charging and pre-discharging device is defined clearly, enabling a great improvement of working efficiency.

### BRIEF DESCRIPTION OF THE DRAWINGS

FIG. 1 shows a structure diagram of the disclosure;

FIG. 2 shows a structure diagram of a master switch device in the disclosure; and

FIG. 3 shows a structure diagram of a master control cabinet in the disclosure.

In the figures, 1 represents a charging-discharging device, 2 a represents a master control cabinet, 21 represents a load control switch, 22 represents a UPS power supply unit, 23 represents a computer monitoring unit, 24 represents a UPS output conversion unit, 25 represents a three-phase input conversion unit, 26 represents a current busbar, 3 represents a master switch device, 31 represents a PCS high-voltage output unit, 32 represents a high-voltage output control and protection unit, 33 presents a three-phase power input unit, 4 represents a terminal box device, 5 represents test component, and 51 represents a test stub.

### DETAILED DESCRIPTION OF THE EMBODIMENTS

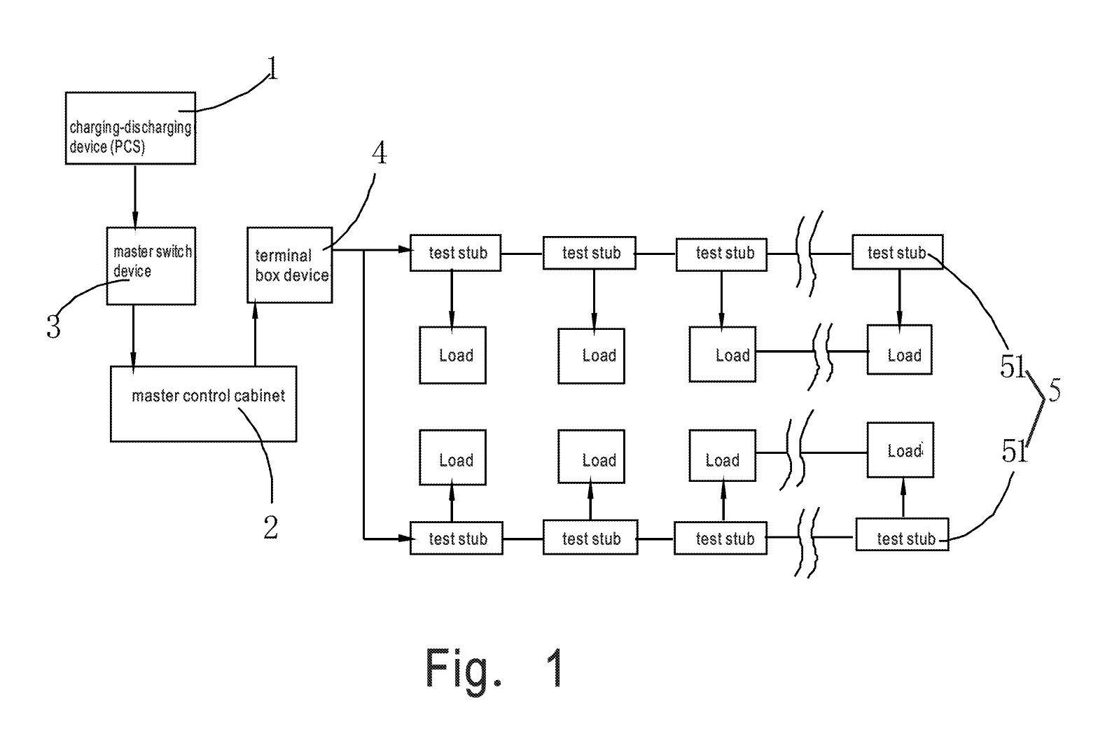

As shown in FIG. 1, a pre-charging and pre-discharging device for an energy storage system provided by the disclosure includes:

a charging-discharging device 1, a master control cabinet 2 used for monitoring a power supply and charging-discharging signals of the charging-discharging device 1, a master switch device 3, a terminal box device 4 used for shunting the input current from the master control cabinet 2 and a test component 5 used for charging a load, wherein the master control cabinet 2 is connected with the energy storage system, the master switch device 3 is connected with the charging-discharging device 1 through a cable and the master switch device 1 is further connected with the master control cabinet 2 (including high-voltage connection, three-phase power connection), the terminal box device 4 is connected with the master control cabinet 2 (including high-voltage connection, mains power connection, communication connection), the test component 5 is connected with the energy storage system (including high-voltage connection, mains power connection, communication connection) and the test component 5 is further connected with the terminal box device 4 through a cable (including high-voltage connection, mains power connection, communication connection).

Here, the cable best is embedded in the ground, to improve the condition of messy wiring.

Here, the energy storage system is provided with SBMS and the master control cabinet is provided with MBMS.

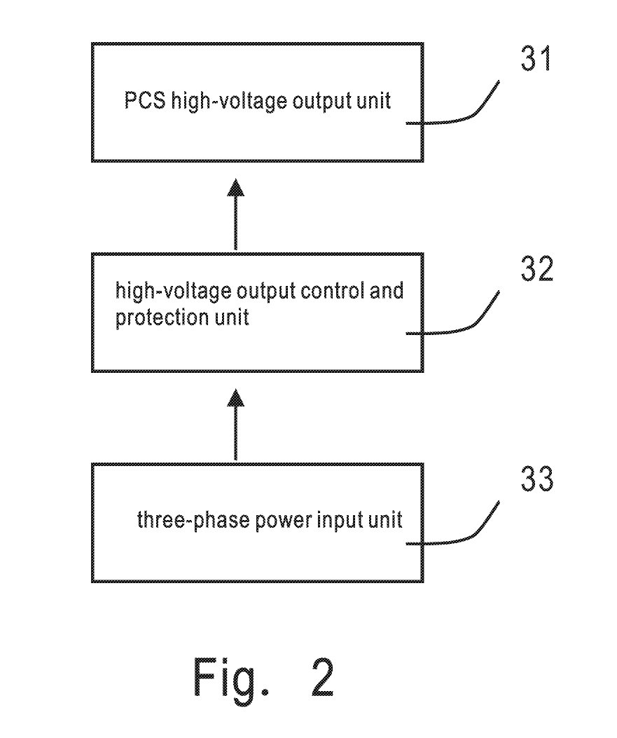

As shown in FIG. 2, the master switch device 3 includes a Power Conversion System (PCS) high-voltage output unit 31, a high-voltage output control and protection unit 32 and a three-phase power input unit 33, wherein the PCS high-voltage output unit 31 plays the role of high voltage output, the high-voltage output control and protection unit 32 plays the role of high voltage output protection and short-circuit protection, the three-phase power input unit 33 plays the role of connecting PCS three-phase power input. Here, PCS refers to the charging-discharging device 1.

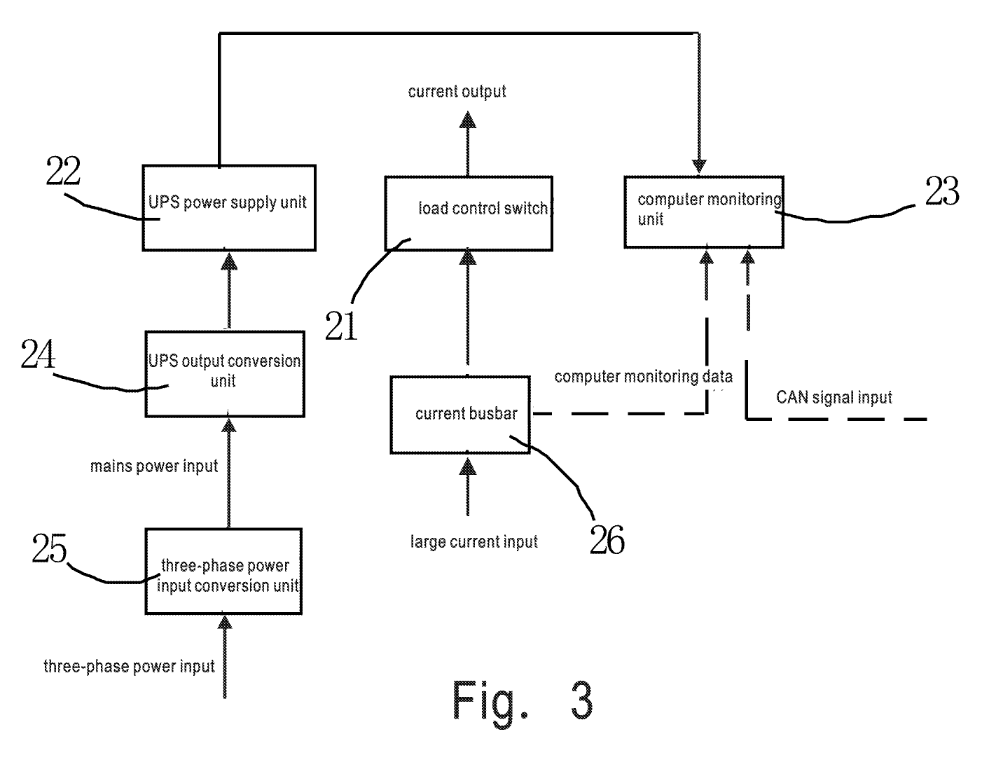

As shown in FIG. 3, the master control cabinet 2 includes: a load control switch 21 used for connecting the energy storage system and the master control cabinet 2, a UPS power supply unit 22, a computer monitoring unit 23 used for connecting with the communication and transceiving instruction (CAN signal and computer monitoring data) of the energy storage system to control the SBMS of the energy storage system, a UPS output conversion unit 24, a three-phase power input conversion unit 25 used for converting three-phase power into mains supply input, a current busbar 26 used for converging the current sent from the master switch device 3, wherein the current busbar 26 mainly is used when large current is input and output.

The three-phase power supplies power to the computer monitoring unit 23 after passing through the three-phase power input conversion unit 25, the UPS output conversion unit 24 and the UPS power supply unit 22; and the mains power supplies power to the computer monitoring unit 23 after passing through the UPS output conversion unit 24 and the UPS power supply unit 22.

The terminal box device 4 includes: a first high-voltage input unit used for inputting the high voltage supplied by the master control cabinet 2 to the test component 5, a first mains power input unit used for inputting the mains power to the energy storage system, and a first communication unit used for connecting the energy storage system and the master control cabinet 2 by ways of signal.

The test component 5 includes a plurality of test stub groups.

Each test stub group includes 2 to 20 test stubs 51.

As shown in FIG. 5, the test stub 51 includes: a second high-voltage input unit used for inputting the high voltage output by the terminal box device 4 to the energy storage system, a second mains power input unit used for inputting the mains power to the energy storage system, and a second communication unit used for connecting the energy storage system and the master control cabinet 2 by way of signal.

Through the above connection, the disclosure achieves functions as follows:

1. Input of high-voltage: the charging-discharging device 1 sends out high-voltage electricity, which is input to the current busbar 26 of the master control cabinet 2 after the shunting control of the master switch device 3; then, the master control cabinet 2 outputs the high-voltage electricity to the terminal box device 4, and the terminal box device 4 outputs the high-voltage electricity to the test component 5 and finally to the energy storage system, thereby completing the action of high voltage input.

2. Input of three-phase power: the PCS supplies three-phase power to the master switch device 3 and the master switch device 3 inputs the three-phase power to the master control cabinet 2; then, the master control cabinet 2 converts the three-phase power into mains power input and inputs the mains power to the terminal box device 4; later, the terminal box device 4 inputs the mains power to the test component 5 and then to the energy storage system so as to provide main power input; and finally, high-voltage input and output is performed through the closing of the relay of the energy storage system, after the mains power is converted into DC 24V.

3. Communication: the SBMS of the energy storage system directly inputs a signal to the MBMS of the master control cabinet 2 connected with the terminal box device 4 through the connection between the test stub 51 and the terminal box device 4; then, the master control cabinet 2 can monitor each energy storage system in time.

4. Protection: (1) voltage protection: when the energy storage system applies a chemical energy storage system, for example, battery pack, the MBMS reads from the SBMS the single-cell voltage and the overall voltage of the battery pack in the energy storage system; when the overall voltage or the single-cell voltage is close to a warning threshold, software displays warning information and reduces the charging current; when the overall voltage or the single-cell voltage reaches the threshold, the MBMS sends an instruction to break the main positive relay of the energy storage system, and to cut off the circuit between the charging-discharging device 1 and the energy storage system so as to stop charging/discharging and prevent overcharge or over-discharge of the single cell, thereby realizing protection.

(2) Temperature protection: when the temperature of the energy storage system reaches a threshold, the master control cabinet sends an instruction to the SBMS of the energy storage system to start a fan arranged in the energy storage system, so as reduce temperature.

(3) Capacity control: the MBMS program of the master control cabinet 2 is set to control the charging-discharging device 1 when SOC reaches certain value (for example, 95%), so as to reduce charging current; charging/discharging the energy storage system with a small current enables a more accurate capacity in the energy storage system.

To sum up, the disclosure can monitor the temperature in time during the charging/discharging process of the energy storage system, can monitor and protect the voltage threshold of each single cell during the charging/discharging process of the energy storage system, and can monitor the charging/discharging current and voltage difference of the energy storage system in time; moreover, the connection of each unit is defined clearly, enabling a great improvement of working efficiency.

The disclosure has a high intelligence; it is only needed to set a corresponding threshold in the MBMS program to complete the control on the charging and discharging of the energy storage system by the pre-charging and pre-discharging device, without manual switching; therefore, the use safety of the energy storage system is greatly improved; due to reasonable site planning, the disclosure greatly improves the safety performance of online charging, reduces the workload of wiring and improves the efficiency of wiring, and thus can meet the requirement of quick production.

What is claimed is:

1. A pre-charging and pre-discharging device for an energy storage system, including:
a charging-discharging device;
a master control cabinet used for monitoring a power supply and charging-discharging signals of the charging-discharging device, wherein the master control cabinet is connected with the energy storage system;
a master switch device, wherein the master switch device is connected with the charging-discharging device through a cable and the master switch device is further connected with the master control cabinet;
a terminal box device used for shunting the input current from the master control cabinet, wherein the terminal box device is connected with the master control cabinet; and
a test component used for charging a load, wherein the test component is connected with the energy storage system and the test component is further connected with the terminal box device through a cable.

2. The pre-charging and pre-discharging device for an energy storage system according to claim 1, wherein the energy storage system is provided with a Slave Battery Management System (SBMS) and the master control cabinet is provided with a Master Battery Management System (MBMS).

3. The pre-charging and pre-discharging device for an energy storage system according to claim 2, wherein the master switch device includes a Power Conversion System (PCS) high-voltage output unit, a high-voltage output control and protection unit and a three-phase power input unit.

4. The pre-charging and pre-discharging device for an energy storage system according to claim 3, wherein the master control cabinet includes:
a load control switch used for connecting the energy storage system and the master control cabinet;
an Uninterruptable Power Supply (UPS) unit;
a computer monitoring unit used for connecting with the communication and transceiving instruction of the energy storage system to control the SBMS of the energy storage system;
a UPS output conversion unit;
a three-phase power input conversion unit used for converting three-phase power into mains supply input;
a current busbar used for converging the current sent from the master switch device; and
the three-phase power supplies power to the computer monitoring unit after passing through the three-phase power input conversion unit, the UPS output conversion unit and the UPS power supply unit in turn; and the mains power supplies power to the computer monitoring unit after passing through the UPS output conversion unit and the UPS power supply unit in turn.

5. The pre-charging and pre-discharging device for an energy storage system according to claim 1, wherein the terminal box device includes a first high-voltage input unit used for inputting the high voltage supplied by the master control cabinet to the test component, a first mains power input unit used for inputting the mains power to the energy storage system, and a first communication unit used for connecting the energy storage system and the master control cabinet by ways of signal.

6. The pre-charging and pre-discharging device for an energy storage system according to claim 1, wherein the test component includes a plurality of test stub groups.

7. The pre-charging and pre-discharging device for an energy storage system according to claim 6, wherein each test stub group includes 2 to 20 test stubs.

8. The pre-charging and pre-discharging device for an energy storage system according to claim 7, wherein the test stub includes: a second high-voltage input unit used for inputting the high voltage output by the terminal box device to the energy storage system, a second mains power input unit used for inputting the mains power to the energy storage system, and a second communication unit used for connecting the energy storage system and the master control cabinet by ways of signal.
